(19) United States
(12) Patent Application Publication
(10) Pub. No.: US 2006/0096721 A1
(43) Pub. Date: May 11, 2006

(54) Frame support mechanism

(76) Inventor: Glen Jones, Pearland, TX (US)

Correspondence Address: HICKMAN PATENT LAW OFFICES, 4640 CEDAR STREET, BELLAIRE, TX, 77401, US

(21) Appl. No.: 10/972,225

(22) Filed: Oct. 22, 2004

(51) Int. Cl. E05D 15/26

(52) U.S. Cl. 160/203

(57) ABSTRACT

A system for supporting a frame including a frame, a support, a mechanism rigidly connected to the frame, and movably connected to the support, and a linkage system comprising a first linkage member connected to the frame, a second linkage member pivotally connected to a structure and pivotally connected to the first linkage member.

### FIELD

The present disclosure is related to mechanisms for supporting a frame.

### BACKGROUND

U.S. Pat. No. 6,719,033 issued Apr. 13, 2004, discloses the novel placement of two pairs of vertical track disposed adjacent to each other together with a pair of radiused horizontal tracks being attached to the outer pair of vertical tracks allowing the use of a flexible lift and reverse cable system to open, close and reverse multi-paneled garage doors. Use of an inner and outer pair of vertical tracks disposed adjacent to each other allows the lowermost rollers to be guided on the inner vertical tracks and the remaining rollers to be guided on the outer vertical tracks and, ultimately, the horizontal tracks as the garage door opens. This configuration allows the lift cable a clear pathway to travel from the drum down the center of the inner vertical tracks to the connection with the shaft journal mounted near the bottom of the garage door. The reverse cable also has a free pathway from its connection to the shaft journal at the lower portion of the garage door, down around the pulley located adjacent to the bottom of the garage door and then upwardly toward the back side of the cable drum and, ultimately, connection with the lift cable to form a continuous loop without interfering with the rollers. This configuration ensures that the lift and reverse cables move simultaneously, thus maintaining the constant tension in the continuous loop of cable necessary to provide the required safety feedback mechanism case an obstruction is encountered during the closing operation. U.S. Pat. No. 6,719,033 is herein incorporated by reference in its entirety.

U.S. Pat. No. 6,651,723 issued Nov. 25, 2003, discloses garage door (12) opening/closing system (10) comprising a garage door (12) having top (32), bottom (34), and first and second sides (54, 56) and having a series of rollers (58) associated with the first and second sides (54, 56); a pair of door rails (14, 16) at the first and second sides (54, 56) of the door (12) for receiving the rollers (58) for movement of the door along the rails (14, 16), in a door opening path; at least one hinge part mounted on the door intermediate the first and second ends (54, 56); a central guide rail (18) extending outwardly from the plane of a closed position of the door (12) from a position above the top (32) of the door (12); a trolley (20) mounted on the central guide rail (18) for movement along the guide rail, the trolley (20) for operative connection to at least one hinge part; at least one cable drum (22) having a pair of cables (26, 28) thereon operatively associated with the trolley for moving the trolley (20) along the central guide rail (18); and operator means operatively associated with at least one drum for driving at least one drum. U.S. Pat. No. 6,651,723 is herein incorporated by reference in its entirety.

U.S. Pat. No. 5,964,269 issued Oct. 12, 1999, discloses a garage door bracing arrangement comprising a plurality of vertically extending door-stiffening column members, which are pivotally attached to upper mounting brackets affixed to garage building structure directly above the garage door opening. Lower mounting brackets are affixed to second ends of the column members and are anchored to the garage floor directly beneath the upper mounting brackets. The door-stiffening column members are configured as generally hollow, rigid, telescoping sections having longitudinal channels which retain fasteners that project from sides of the telescoping sections, so as to pass through holes in mounting brackets that affix the door-stiffening column members to the garage building structure, and deflection brackets that secure the door-stiffening column members to door panel hinge joints. The upper mounting bracket is configured to allow for a pivot swing type of movement, that eliminates pull stress from the upper bracket, when the bracing system is placed in an outward or suction condition created by high cross winds. U.S. Pat. No. 5,964,269 is herein incorporated by reference in its entirety.

U.S. Pat. No. 5,732,758 issued Mar. 31, 1998, discloses a support assembly for doors, garage doors, or window shutters that cover building apertures. A support bar is mounted on a pivoting mount. Spring loaded locking assemblies are actuated by a lever assembly. With the locking assemblies retracted, the support can be pivoted from a horizontal passive position to a vertical engaged position. As the support assembly bar approaches the vertical position, the top lock assembly engages a top fixture and the bottom lock assembly engages a bottom fixture which are attached to the structure. External forces on the door or the shutter are transferred through the engaged support bar, through the fixtures, and to the building. The support bar mountably stays attached to the aperture cover, or door, in the passive position when the cover or door is opened. U.S. Pat. No. 5,732,758 is herein incorporated by reference in its entirety.

U.S. Pat. No. 5,572,829 issued Nov. 12, 1996, discloses a power operated garage door of the type having a single section movable from a vertical closed position to a horizontal open position at the ceiling of the garage by cables which pull the door open and closed and are secured to the door by extensions of the journal bearings for pivotally supporting the lower edge of the door. U.S. Pat. No. 5,572,829 is herein incorporated by reference in its entirety.

U.S. Pat. No. 5,341,597 issued Aug. 30, 1994, discloses a power operated door which fits into a wall opening with an outer surface flush with the outer wall surface and displaceable upwardly to a horizontal open position by tilting the top of the door inwardly and then sliding it in vertical and horizontal tracks to the open position. A first drive mechanism on the door tilts it about a lower bearing and a second drive mechanism drives the door upwardly and downwardly by means of flexible connectors which pull upwardly and downwardly on the bottom of the door. U.S. Pat. No. 5,341,597 is herein incorporated by reference in its entirety.

U.S. Pat. No. 4,852,300 issued Aug. 1, 1989, discloses a pair of stacking gates or doors having a trailing gate and a leading gate which roll along parallel tracks between a retracted position with the gates approximately side-by-side and an extended position with the leading gate further from the retracted position than the trailing gate. Flexible roller chains are used to retract and extend the gates. A retraction chain has one end connected to an anchor fixed between the gates, is wrapped around a rear idler sprocket on the rear of the trailing gate, and is connected at the other end to the leading gate. An extension chain has one end connected to the fixed anchor, is wrapped around a front idler sprocket near the front of the trailing gate, and is connected at the other end to the rear of the leading gate. As the trailing gate is moved, the idlers move, changing the lengths of the reaches of chain and moving the leading gate twice as far as movement of the trailing gate. U-shaped brackets at the top of the gates maintain the top of the leading gate spaced apart a uniform distance from the top of the trailing gate. U.S. Pat. No. 4,852,300 is herein incorporated by reference in its entirety.

U.S. Pat. No. 4,793,398 issued Dec. 27, 1988, discloses an articulating door which is fixed to a torque tube through a plurality of structural tube elements and gussets. The torque tube is rotatably fixed to the building. A sprocket, which is engaged to the torque tube, is driven by an electric motor and gear reduction drive, and a chain reduction drive. An arm assembly and counterbalance element counterbalance the door as it moves between its open and closed positions. In its open position, the door remains folded exteriorly of the building. U.S. Pat. No. 4,793,398 is herein incorporated by reference in its entirety.

U.S. Pat. No. 4,765,093 issued Aug. 23, 1988, discloses an overhead tilt door assembly for use with a wide range in size of framed openings from small garage doors to very large aircraft hangar doors. The door is a one-piece unit. The door is suspended on cables which distribute its weight over the top of the framed door opening. There are only four rollers used in the system. Two are mounted halfway up the door, one on each end and are mounted in vertical tracks. There are two other rollers mounted one on each end of the door near the top which are installed in very short vertical tracks attached to short radius ninety degree curved tracks that are fastened to horizontal tracks. Locking pins are provided at the bottom of the door and when the door is closed, the pins engage holes in the floor of the doorway to give added stability. No counterweights or springs are necessary, although counterweights may be helpful in some applications. U.S. Pat. No. 4,765,093 is herein incorporated by reference in its entirety.

U.S. Pat. No. 4,443,972 issued Apr. 24, 1984, discloses an overhead tilting door assembly, particularly for use in large buildings. The door assembly includes a door member having a quadrant member attached to each of its upper corners. Generally horizontal support members are provided on either side of the door member extending rearwardly therefrom. Each quadrant member is rolled along a support member to tilt the door between open and closed positions. A drive means is pivotally attached to a quadrant member for tilting the door member and for locking the door member against movement, unless being tilted by the drive means. The assembly also includes anti-skid means between the quadrant members and the support members to force the quadrant members to roll and not skid along the support members. U.S. Pat. No. 4,443,972 is herein incorporated by reference in its entirety.

U.S. Pat. No. 4,192,100 issued Mar. 11, 1980, discloses a sliding door apparatus for closing large openings in large building structures. There is disclosed a sliding door engaged with a building structure and having at least one edge aligned to slide parallel to a portion of the door frame, the edge and frame portion defining a gap therebetween and constituting two relatively moveable adjacent members one of which has a magnetically receptive surface extending along the gap, the other having a flexible magnetic sealing strip along the gap and spanning the gap to magnetically engage the surface when the sliding door is closed. U.S. Pat. No. 4,192,100 is herein incorporated by reference in its entirety.

Multi-paneled doors provide insufficient strength to cover large openings. Multipaneled doors cannot be as wide as a tilt door or a sliding door. Sliding doors require space to the sides of the opening to place the sliding door or doors, after opening the sliding doors. Tilt doors require a large amount of vertical and/or horizontal clearance to open and close.

There is a need in the art for a tilt door or frame which requires a minimal amount of clearance to open and close.

### SUMMARY

A system for supporting a frame including a frame, a support, a mechanism rigidly connected to the frame, and movably connected to the support, and a linkage system comprising a first linkage member connected to the frame, a second linkage member pivotally connected to a structure and pivotally connected to the first linkage member.

### BRIEF DESCRIPTION OF THE DRAWINGS

FIG. 1 illustrates a side view of a frame support system, with the frame in a closed position;

FIG. 2 illustrates a side view of a frame support system, with the frame in a partially opened position;

FIG. 3 illustrates a side view of a frame support system, with the frame in an opened position;

FIG. 4 illustrates a side view of a frame support system;

FIG. 5 illustrates a front view of a frame support system; and

FIG. 6 illustrates a side view of a frame support system.

### DETAILED DESCRIPTION

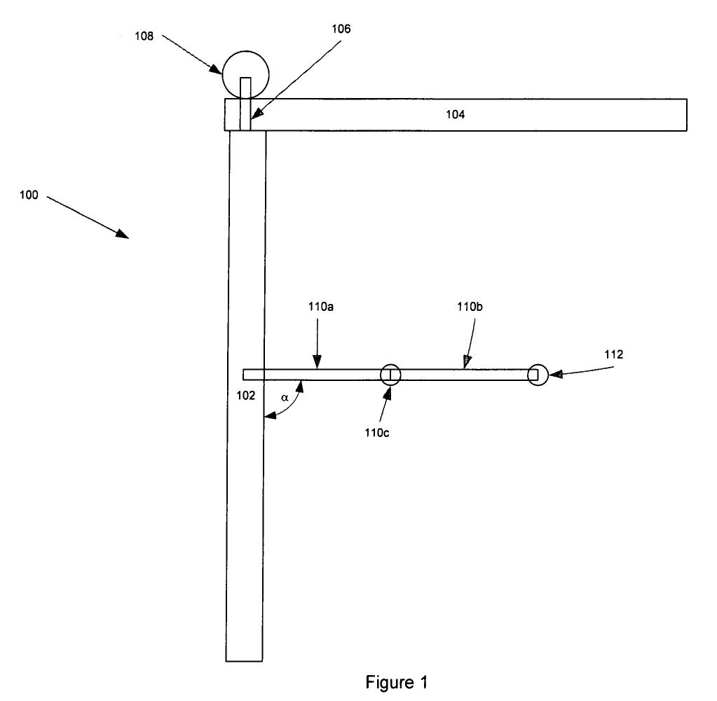

In one embodiment, referring to FIGS. 1-3, there is illustrated a door system 100. Door system 100 includes door 102, shown in side view in FIGS. 1-3. Door 102 is hung from support 104 by sliding and/or rolling mechanism 108 connected to door 102 by member 106.

Door 102 is also rigidly connected to linkage system 110 at an angle α, including first linkage member 110a, second linkage member 110b, and pivot 110c. Linkage system 110 is connected to a pivot point 112, in one embodiment a fixed pivot point.

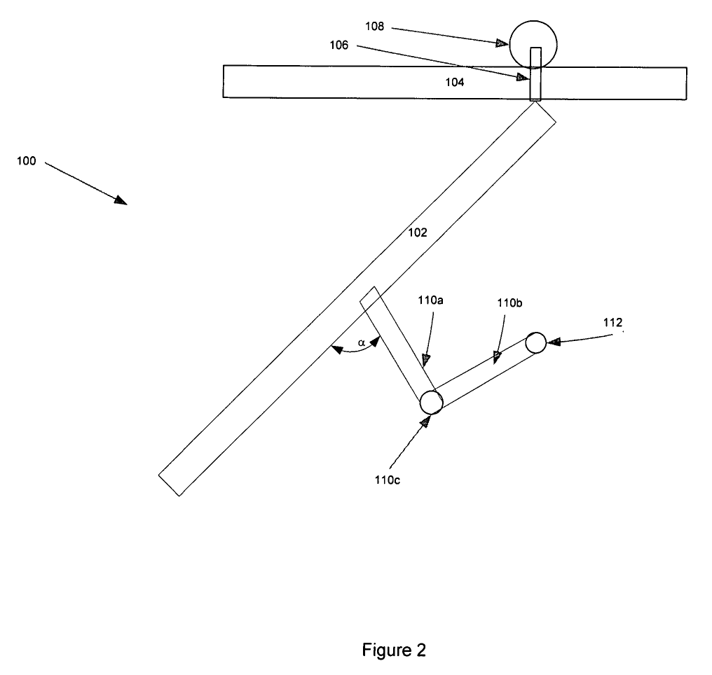

In FIG. 2, door 102 is being opened by moving sliding mechanism 108 relative to support 104 to displace member 106 and the top of door relative to support 104. First linkage member 110a and second linkage member 110b rotate about pivot 110c to maintain door 102 at a desired angle as door 102 is opened. Member 106 pulls the top of door 102 to the right, while linkage system 110 rotates door open, as linkage member 110a is rigidly connected to door 102 at an angle α and pivot point 112 remains stationary.

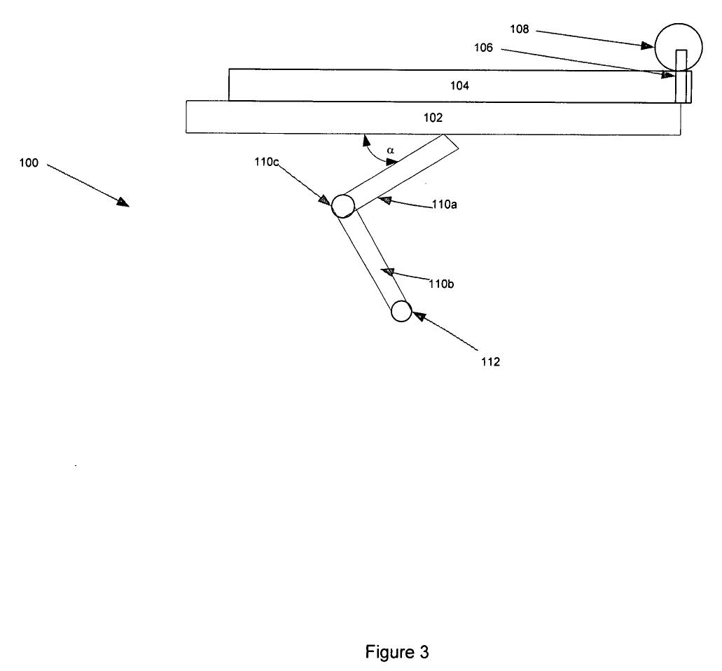

In FIG. 3, door 102 has been fully opened by moving sliding mechanism 108 relative to support 104 to displace member 106 and the top of door relative to support 104. First linkage member 110a and second linkage member 110b have rotated about pivot 110c to hold door 102 horizontally in the open position. Member 106 pulled the top of door 102 to the right, while linkage system 110 rotates door to the horizontal position.

To close door 102, sliding mechanism 108 is moved to the left, which moves member 106 to left and the top of the door 102 to the left. As door is closing, linkage system 110 gradually lowers door 102 from a horizontal to a vertical position as the top of the door 102 is moving to the closed position.

In one embodiment, door 102 comprises a rigid frame with a skin attached, for example, welded metal beams making up the frame with sheet-metal attached to the frame. In another embodiment, door 102 comprises only a rigid frame with no skin attached which door 102 may be used as a gate.

In one embodiment, support 104 is substantially horizontal. In another embodiment, support 104 is upwardly inclined from left to right. In another embodiment, support 104 is downwardly inclined from left to right.

In another embodiment, linkage system 110 may have the lengths of first linkage member 110a and second linkage member 110b, and/or the placement of pivot point 112 adjusted as necessary depending on the geometries of door 102, the opening, the placement of support 104, and/or the building to which the door and/or opening correspond.

In another embodiment, sliding mechanism 108 may include a wheel which rotates or rolls to move on support 104. In another embodiment, sliding mechanism 108 may include gears which mate with corresponding gears on support 104.

In another embodiment, a motor is provided to displace sliding mechanism 108 relative to support 104. In another embodiment, a biasing mechanism is provided to bias sliding mechanism 108 towards the open position relative to support 104, for example a spring.

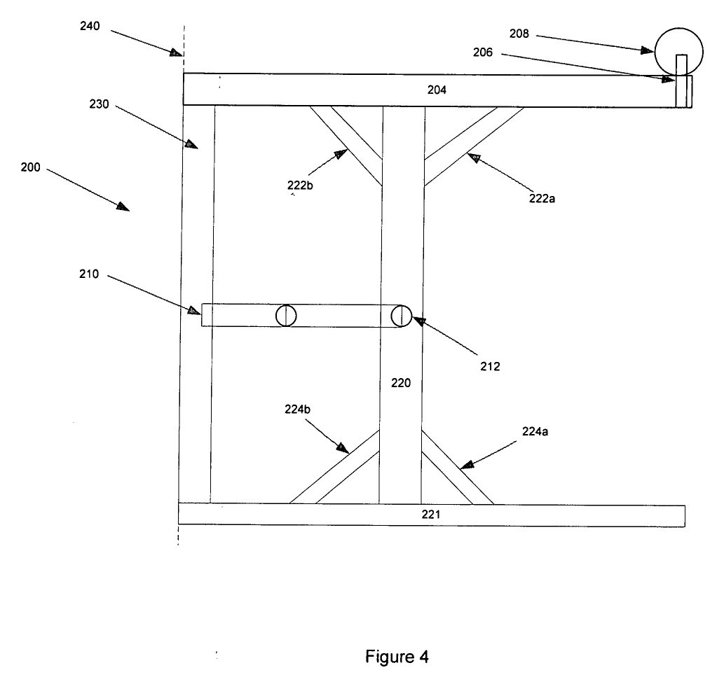

Referring now to FIG. 4, there is illustrated support structure 200 which may be used to support a door or frame, for example door 102. Support structure 200 includes support 204, which is movably attached to mechanism 208 and member 206, which is adapted to be connected to a door or frame. Linkage system 210 is pivotally connected to support structure 200 by pivot 212. Support 204 is connected to vertical member 220 and truss members 222a and 222b. Vertical member 220 is connected to horizontal member 221 and truss members 224a and 224b. Vertical member 230 is connected to horizontal member 204 and horizontal member 221. Horizontal member 221 is adapted to rest on the ground or on the floor of a building. Truss members 222a and 222b and truss members 224a and 224b are adapted to provide structural support to support structure 200.

In one embodiment, two support structures 200 are provided to support a door or frame, for example one on either side of the door or frame.

In one embodiment, support structure 200 is freestanding and rests on the floor or ground. In another embodiment, support structure 200 is attached to a building or other structure to provide additional stability and strength.

In another embodiment, horizontal member 221 is rigidly attached to the floor or ground, for example by being bolted or welded to a foundation, piers, or pilings.

In another embodiment support structure 200 may be placed adjacent to opening 240 of a building or other structure.

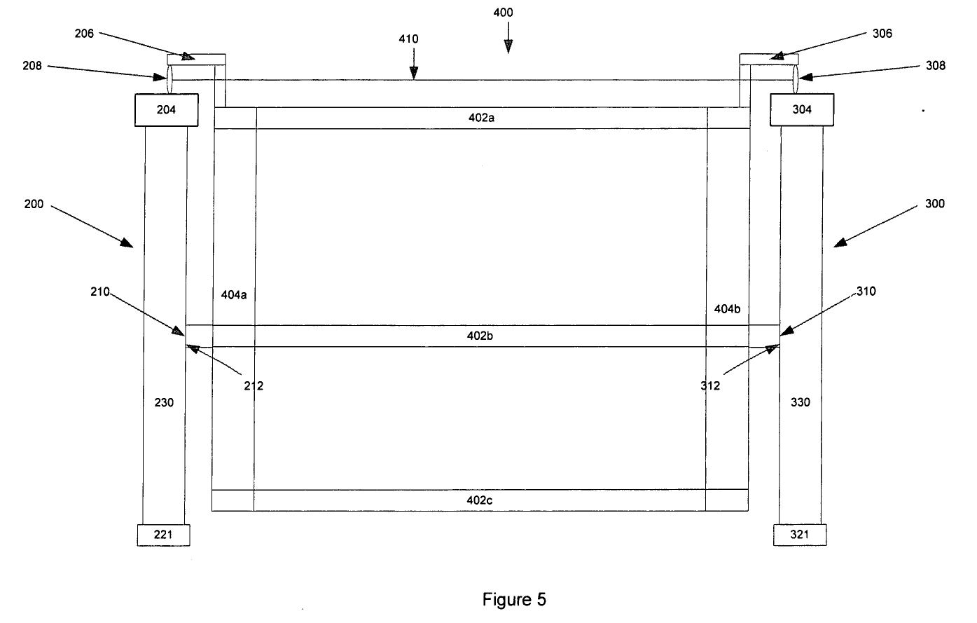

Referring now to FIG. 5, there is illustrated a front view of support structure 200, support structure 300, and frame 400.

Support structure 200 includes support 204, which is movably attached to mechanism 208 and member 206, which member 206 is connected to a portion of frame 400, for example the intersection of horizontal member 402a and vertical member 404a. Linkage system 210 is pivotally connected to support structure 200 by pivot 212, and to a portion of frame 400, for example the intersection of horizontal member 402b and vertical member 404a. Support 204 is connected to vertical member 220 and truss members 222a and 222b. Vertical member 220 is connected to horizontal member 221. Horizontal member 221 is adapted to rest on the ground or on the floor of a building.

Support structure 300 includes support 304, which is movably attached to mechanism 308 and member 306, which member 306 is connected to a portion of frame 400, for example the intersection of horizontal member 402a and vertical member 404b. Linkage system 310 is pivotally connected to support structure 300 by pivot 312, and to a portion of frame 400, for example the intersection of horizontal member 402b and vertical member 404b. Support 304 is connected to vertical member 320. Vertical member 320 is connected to horizontal member 321. Horizontal member 321 is adapted to rest on the ground or on the floor of a building.

Frame 400 includes horizontal members 402a, 402b, and 402c which are rigidly connected to vertical members 404a and 404b. In another embodiment, additional horizontal members and/or vertical members may be provided. In one embodiment, horizontal members are bolted to vertical members. In another embodiment, horizontal members are welded to vertical members.

In one embodiment, shaft 410 is provided and connects mechanism 208 to mechanism 308.

In another embodiment, shaft 410 is provided and connects mechanism 208 to mechanism 308, and mechanism 208 is provided with gears which mate with corresponding gears on support 204, and mechanism 308 is provided with gears which mate with corresponding gears on support 304. Gears on mechanisms 208 and 308 and shaft 410 serve to move both sides of the frame 400 at the same rate.

In operation, frame 400 may be moved from the vertical position (as illustrated in FIG. 5) to a horizontal position in substantially the same manner as illustrated in FIGS. 1-3. Mechanisms 208 and 308 are displaced relative to supports 204 and 304, and linkage systems 210 and 310 are used to rotate frame 400 from a vertical to a horizontal position as mechanisms 208 and 308 are displaced.

In another embodiment, a skin (not shown) may be attached to frame 400, to convert frame 400 into a door. The skin may be sheet-metal, a polymer sheet, wood, or another suitable skin.

In another embodiment, support structure 200, support structure 300, and frame 400 may be used as a security gate, where horizontal members 221 and 321 are rigidly attached to the ground, and frame 400 may be used to stop the progress of a speeding vehicle.

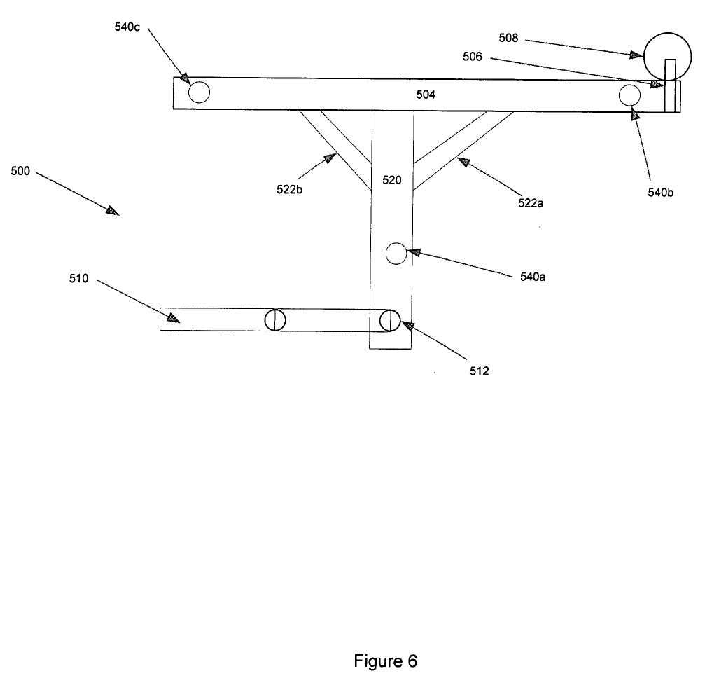

Referring now to FIG. 6, there is illustrated support structure 500 which may be used to support a door or frame, for example door 102. Support structure 500 includes support 504, which is movably attached to mechanism 508 and member 506, which is adapted to be connected to a door or frame. Linkage system 510 is pivotally connected to support structure 500 by pivot 512. Support 504 is connected to vertical member 520 and truss members 522a and 522b. Vertical member 520 is connected to a structure, for example a building, or pillar, by connector 540a. Horizontal member 504 is connected to a structure, for example a building, or pillar, by connectors 540b and 540c. Truss members 522a and 522b are adapted to provide structural support to support structure 500.

In one embodiment, two support structures 500 are provided to support a door or frame, for example one on either side of the door or frame.

In another embodiment, support structure 500 is attached to a building or other structure to provide stability and strength.

The above-described embodiments of the present disclosure include a number of reference numerals provided to aid in the understanding of the disclosed devices and methods. Although the same or similar reference numerals have been used in multiple figures and for multiple embodiments for the sake of convenience, it should not be assumed that the same reference numeral refers to the same element or that similarly numbered elements are the same element in each of the figures and embodiments.

The above description of the embodiments according to the disclosure are merely examples, and, thus, variations that do not depart from the gist of the disclosure are intended to be within its scope. Such variations are not to be regarded as a departure from the spirit and scope of the invention. In addition, the various embodiments discussed above are used to illustrate the components and functioning of the systems and methods, and should not be used to interpret the scope of the claims set forth below.

1. A system for supporting a frame comprising:
a frame;
a support;
a mechanism rigidly connected to the frame, and movably connected to the support;
a linkage system comprising a first linkage member connected to the frame, a second linkage member pivotally connected to a structure and pivotally connected to the first linkage member.

2. The system of claim 1, wherein the mechanism comprises a sliding mechanism.

3. The system of claim 1, wherein the mechanism comprises a rolling mechanism.

4. The system of claim 1, wherein the support comprises male gear members, and the mechanism comprises female gear members adapted to mate with the male gear members.

5. The system of claim 1, wherein the first linkage member is rigidly connected to the frame.

6. The system of claim 1, further comprising a motor connected to the mechanism, adapted to reversibly move the frame from an open to a closed position.

7. A system for supporting a frame comprising:
a frame;
a support means;
a movable means rigidly connected to the frame, and movably connected to the support;
a linkage means connected to the frame and pivotally connected to a structure.

8. A linkage system comprising:
a first linkage member connected to a frame;
a second linkage member pivotally connected to a structure and pivotally connected to the first linkage member.

9. A frame system comprising:
a frame;
a first support on a first side of the frame;
a second support on a second side of the frame;
a first mechanism rigidly connected to the frame, and movably connected to the first support;
a second mechanism rigidly connected to the frame, and movably connected to the second support;
a first linkage system comprising a first linkage member connected to the frame, a second linkage member pivotally connected to a first structure and pivotally connected to the first linkage member;
a second linkage system comprising a third linkage member connected to the frame, a fourth linkage member pivotally connected to a second structure and pivotally connected to the third linkage member.

10. The system of claim 9, wherein at least one of the first mechanism and second mechanism comprises a rolling mechanism.

11. The system of claim 9, wherein the first support comprises male gear members, and the first mechanism comprises female gear members adapted to mate with the male gear members.

12. The system of claim 11, wherein the second support comprises male gear members, and the second mechanism comprises female gear members adapted to mate with the male gear members.

13. The system of claim 12, further comprising a rigid shaft connected to the first mechanism and the second mechanism.

14. The system of claim 9, wherein the first linkage member is rigidly connected to the frame.

15. The system of claim 9, further comprising a motor connected to the first mechanism, adapted to reversibly move the frame from an open to a closed position.

16. A method of constructing a frame, comprising:
providing a frame;
connecting a mechanism to the frame;
movably connecting the mechanism to a support;
connecting a linkage system to the frame, wherein the linkage system comprises at least a first linkage member and a second linkage member; and
connecting the linkage system to a support.

17. The method of claim 16, further comprising attaching a metal skin to the frame.
